(19) United States
(12) Patent Application Publication
(10) Pub. No.: US 2007/0103601 A1
(43) Pub. Date: May 10, 2007

(54) Image data processing apparatus and method of processing image data

(75) Inventor: Takehito Izumi, Mihama-ku (JP)

Correspondence Address: OLIFF & BERRIDGE, PLC, P.O. BOX 19928, ALEXANDRIA, VA, 22320, US

(73) Assignee: KAWASAKI MICROELECTRONICS, INC., MIHAMA-KU (JP)

(21) Appl. No.: 11/593,080

(22) Filed: Nov. 6, 2006

(30) Foreign Application Priority Data
Nov. 7, 2005 (JP) 2005-321674

(51) Int. Cl. H04N 5/57

(52) U.S. Cl. 348/687

(57) ABSTRACT

The brightness characteristic detection circuit 1 divides the frame 21 into a plurality of pixel blocks 22, detects average brightness characteristics of respective pixel blocks, and obtains the maximum or minimum brightness value of input image data from the average brightness characteristics of the pixel blocks. Correcting input image data with correction parameters set in accordance with the detected maximum or minimum brightness value generates display data. Even if a noise is incorporated in the image data, the influence of the noise is suppressed and the image data may be processed accurately.

Exemplary embodiments of this invention were first described in Japanese Patent Application No. 2005-321674, which is hereby incorporated by reference in its entirety.

### BACKGROUND

Exemplary embodiments of this invention relates to image data processing apparatus that generates a display data to be output to display devices from image data input to the apparatus. This invention also relates to methods of processing image data.

In image data display apparatus, a technique is known to improve the contrast of displayed image by performing g-compensations in accordance with the APL (Average Picture Level) of the image signal. That is, of gray-scale levels of bright or dark portions are corrected in accordance of the APL value.

For example, Japanese Laid-open Patent No. Hei 6-6820 (Patent Document 1) proposes a technique to prepare a plurality of g-compensation memories for storing respective g-compensation values and to select one of the memories, so that the contrast of the display device is improved by performing the g-compensation in accordance with the APL value. The technique proposed in Patent Document 1 does not ensure that, however, the γ-compensation most suitable for the displayed image is performed, because the same g-compensation memory is selected for different scenes if the APL values are the same. When the APL value is low, for example it is not distinguishable between an image that the entire areas are moderately dark and an image that has a bright area within very dark background. As a result, the same g-compensation memory is selected for both of the scenes.

On the other hand, Japanese Laid-open Patent 2001-343957 (Patent Document 2) proposes, in order to solve the above-mentioned problem, to detect the maximum/minimum values of brightness within the frame. That is, the minimum brightness and the maximum brightness are detected for each frame, and setting the brightness characteristic of the display image in accordance with the detected values enhances the contrast. Thereby enables a further precise display of the image. For example, it becomes possible to distinguish between the images that the entire areas are moderately dark and the image that has a bright area within very dark background, even if the APL values of respective images are low and the same. Accordingly, it is possible to select g-compensation memories suitable for the respective images.

The method of detecting the maximum brightness value and the minimum brightness value in the frame disclosed in Patent Document 2 is as follows: serially inputting into a comparator input image data and the brightness held in a latch, which in the maximum or the minimum brightness data among the previously input data, and re-holding the larger or the smaller one of the data into the latch depending on the result of the comparison.

However, the method of obtaining the maximum or the minimum brightness value of each frame by comparing all of the image data in the frame has problems when some types of noises are incorporated in the image data of the frame. When, for example, an extremely bright pixel exists as a noise in overall dark image, the brightness value of the extremely bright pixel, which is the noise, is stored as the maximum brightness in the latch. While, when an extremely dark pixel exists as a noise in overall bright image, the brightness value of the extremely dark pixel, which is the noise, is stored as the minimum brightness in the latch. If the g-compensation is performed in accordance with thus obtained maximum or minimum brightness value because of the noise, the compensation is performed differently from what should be.

### SUMMARY

Various exemplary embodiments of this invention provide an image data processing apparatus, and a method of image processing that is capable of performing image data processing, even when a noise is incorporated in the image, with high accuracy by suppressing the influence of the noise. Various exemplary embodiments of this invention also provides a method of detecting a brightness characteristic of image data, even when a noise is incorporated in the image, with high accuracy.

In order to address or solve the above, various exemplary embodiments of this invention provide an image data processing apparatus for generating display data to be output to a display device from input image data. The apparatus includes a brightness characteristic detection circuit that detects a brightness characteristic of the input image data; and a correction circuit that generates the display data by correcting the input image data with a correction parameter set in accordance with the detected brightness characteristic. The image data includes brightness values of pixels in a frame, and the brightness characteristic detection circuit detects the brightness characteristic of the image data by dividing a specified area of the frame into a plurality of divided areas including respective pluralities of the pixels, calculating respective average brightness characteristics of the divided areas, and comparing the average brightness characteristics of the divided areas with each other to obtain at least one of a maximum and a minimum brightness value of the frame.

According to various exemplary embodiments, the detection circuit may calculate accumulated brightness values of the divided areas as the respective average brightness characteristics by accumulating the brightness values of the pixels within each of the divided areas.

According to various exemplary embodiments, the detection circuit may capable of setting respective indexes for the divided areas such that the indexes are considered when comparing the average brightness characteristics of the divided areas.

According to various exemplary embodiments, the detection circuit may divide the specified area of the frame such that the divided areas are arranged in a plurality of rows including respective pluralities of the divided areas, and the detection circuit may include: an accumulator that accumulates the brightness values of the pixels within each of the divided areas to produce the accumulated brightness values of the divided areas; a processing memory capable of storing the accumulated brightness values of the divided areas in any one of the rows produced by the accumulator; and a comparator that selects at least one of a largest and a smallest one of the accumulated brightness values of the divided areas stored in the processing memory.

In order to solve above-described problems, various exemplary embodiments of this invention provide method of processing image data that includes receiving image data including brightness values of a plurality of pixels in a frame; detecting a brightness characteristic of the image data; and generating a display data by correcting the image data with a correction parameter set in accordance with the detected brightness characteristic. The detecting includes: dividing a specified area of the frame into a plurality of divided areas including respective pluralities of the pixels; calculating average brightness characteristics of the divided areas; and comparing the average brightness characteristics with each other to obtain at least one of a maximum and a minimum brightness value of the frame.

According to various exemplary embodiments, the calculating may include accumulating the brightness values of the pixels in each of the divided areas to produce accumulated brightness values of the divided areas as the average brightness characteristics of the divided areas; and the comparing is performed such that at least one of a largest and a smallest one of the accumulated brightness values of the divided areas is selected as the at least one of a maximum and a minimum brightness value of the frame.

According to various exemplary embodiments, the dividing may be performed such that the divided areas are arranged in a plurality of rows including respective pluralities of the divided areas; and the calculating and the comparing may include the steps of: (a1) producing the accumulated brightness values of the divided areas in a first one of the rows and storing the produced accumulated brightness values in respective addresses of a processing memory; (a2) selecting at least one of a largest and a smallest one of the values stored in the processing memory and holding the selected one of values in a register; (a3) producing the accumulated brightness values of the divided areas in a next one of the rows and storing the produced accumulated brightness values in the respective addresses of the processing memory; (a4) selecting the at least one of a largest and a smallest one among the values stored in the processing memory and the value previously held in the register, and holding the selected one of the values in the register; and (a5) repeating the steps (a3) and (a4) until the at least one of a largest and a smallest one of the values among the accumulated brightness values of the divided areas in a last one of the rows stored in the respective addresses of the processing memory and the value previously held in the resister is selected and held in the register as the at least one of a maximum and a minimum brightness value of the frame.

According to various exemplary embodiments, the plurality of pixels of each of the divided areas may be arranged in a plurality of lines; and the accumulated brightness values of the divided areas may be calculated, for each of the rows, by the steps of: (b1) accumulating the brightness values of the pixels in a first one of the lines in each of the divided areas to produce intermediate accumulated brightness values of the divided areas and storing the produced values of the divided areas in the respective addresses of the processing memory; (b2) accumulating the brightness values of the pixels in a next one of the lines in each of the divided areas to the values previously stored in the respective addresses of the processing memory to produce update intermediate accumulated brightness values of the divided areas and storing the produced values of the divided areas in the respective addresses of the processing memory; and (b3) repeating the step (b2) until the brightness values of the pixels in a last one of the lines in each of the divided areas are accumulated and the produced updated intermediate accumulated brightness values of the divided areas are stored in the respective addresses of the processing memory as the accumulated brightness values of the divided areas.

In order to solve above-described problems, various exemplary embodiments of this invention provide method of detecting a brightness characteristic of image data that includes brightness values of a plurality of pixels in a frame. The method includes: dividing a specified area of the frame into a plurality of divided areas including respective pluralities of the pixels; calculating average brightness characteristics of the divided areas; and comparing the average brightness characteristics with each other to obtain at least one of a maximum and a minimum brightness value of the frame.

### BRIEF DESCRIPTION OF THE DRAWINGS

Various exemplary details of apparatus and methods are described. with reference to the following figures, wherein:

FIG. 1 is a block diagram showing a construction of a first exemplary image data processing apparatus according to this invention;

FIG. 2 is a block diagram showing a construction of an exemplary brightness characteristic detection circuit;

FIG. 3 is an exemplary arrangement of pixel blocks in a frame according to an exemplary embodiment;

FIG. 4 is a schematic diagram showing an exemplary order of processing the pixels;

FIG. 5 is a schematic diagram showing an exemplary relationship between the pixel blocks and addresses of the processing memory;

FIG. 6 is a flow chart showing an exemplary procedure for calculating maximum brightness value;

FIG. 7 is an exemplary block diagram showing another exemplary embodiment of brightness characteristic detection circuit;

FIG. 8A is an exemplary arrangement of valid and invalid pixel blocks;

FIG. 8B is exemplary data in the valid bits memory corresponding to the arrangement shown in FIG. 8A;

FIG. 9A is Another exemplary arrangement of valid and invalid pixel blocks; and

FIG. 9B is exemplary data in the valid bits memory corresponding to the arrangement shown in FIG. 9A.

### DETAILED DESCRIPTION OF EMBODIMENTS

### First Embodiment

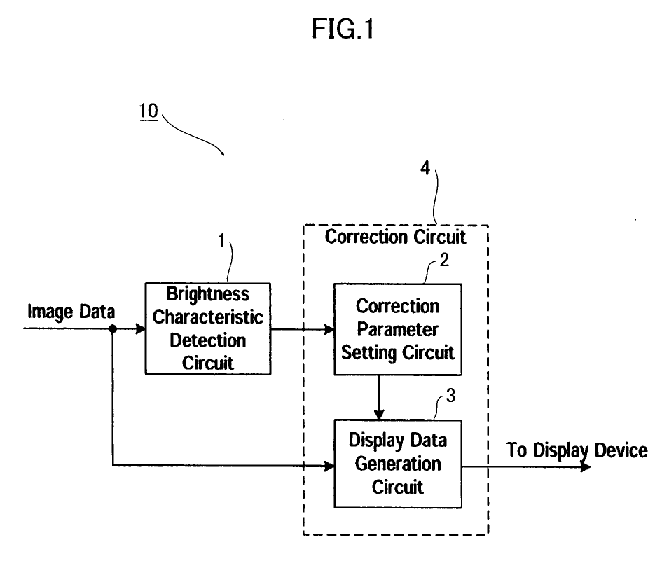

FIG. 1 is a block diagram showing a construction of a first exemplary image data processing apparatus according to this invention. The exemplary apparatus 10 shown in FIG. 1 includes a brightness characteristic detection circuit 1, a correction parameter setting circuit 2, and a display data generation circuit 3. The brightness characteristic detection circuit 1 detects a brightness characteristic of input image data. The correction parameter setting circuit 2 sets parameter or parameters of correction in accordance with the brightness characteristic detected by the detection circuit 1. The display data generation circuit 3 corrects the input image data using the correction parameters set by the correction parameter setting circuit 2 and generates display data to be output to a display device. The correction parameter setting circuit 2 and the display data generation circuit 3 constitutes a correction circuit 4.

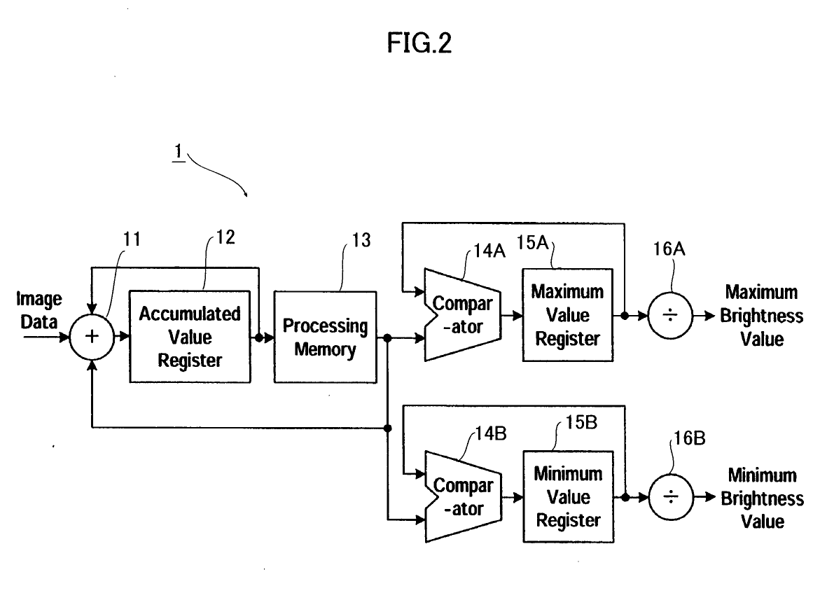

FIG. 2 is a detailed block diagram showing a construction of an exemplary brightness characteristic detection circuit 1. The exemplary brightness characteristic detection circuit 1 includes an adder 11, accumulated value register 12, processing memory 13, comparators 14A and 14B, a maximum value register 15A, a minimum value register 15B, and dividers 16A and 16B. The combination of the adder 11 and the accumulated value register 12 functions as an accumulator.

In this exemplary embodiment, a frame of image is divided into a plurality of divided areas (which will be called as “pixel blocks” hereinafter) including the same numbers of pixels. Accumulated brightness values of respective pixel blocks are calculated by accumulating the brightness values of the pixels included in respective pixel blocks. Moreover, maximum or minimum brightness value of the image data is calculated by comparing the accumulated brightness values of the pixel blocks. Thus, even if a large noise is incorporated in a particular pixel, the influence of the noise may be suppressed.

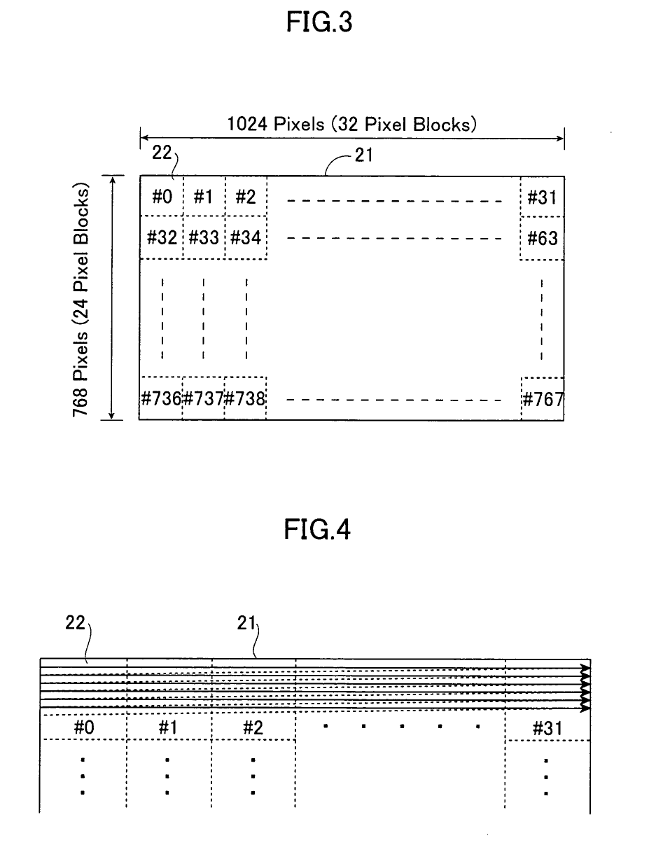

FIG. 3 shows an exemplary arrangement of divided areas (pixel blocks) in a frame according to this exemplary embodiment. The frame 21 is divided into a plurality of pixel blocks 22. As shown in FIG. 3, according to this embodiment, the pixel blocks 22 are arranged in the frame 21 in respective pluralities of rows and columns. Specifically, each pixel block 22 has a size of 32·32 pixels, while the frame 21 has a size of 1024·768 pixels (an XGA frame). Accordingly, number of the pixel blocks 22 arranged in the horizontal direction is 32, and number of the pixel blocks 22 arranged in the vertical direction is 24. In other words, the pixel blocks 22 is arranged in 24 rows each including 32 pixel blocks. Needless to say, however, the size of the pixel block may be set arbitrary.

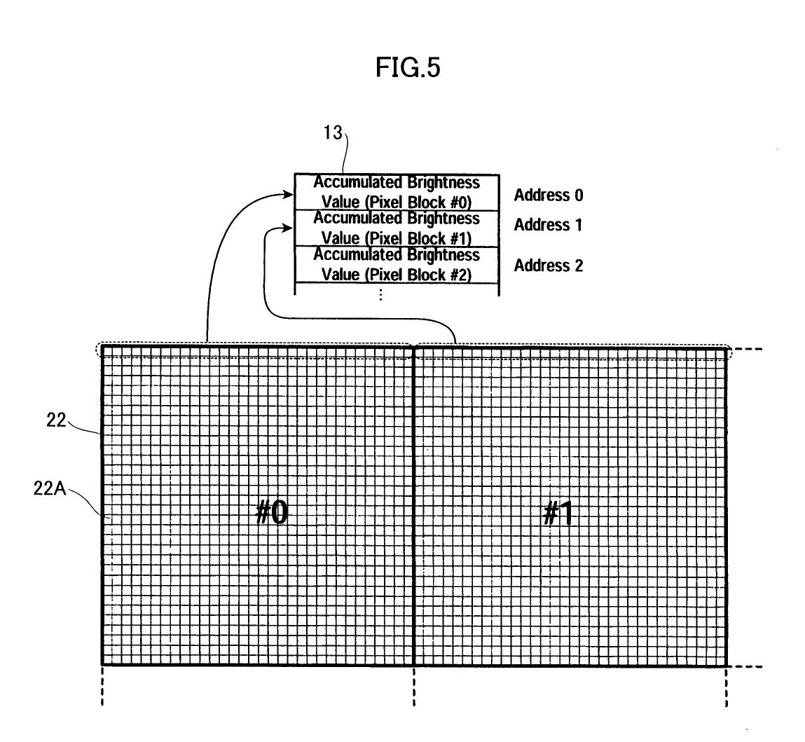

An exemplary procedure for calculating a maximum and a minimum brightness values according to this embodiment will be explained in reference to FIGS. 2 to 5. FIG. 4 is a schematic diagram showing an exemplary order of processing the pixels. FIG. 5 is a schematic diagram showing an exemplary relationship between the pixel blocks and addresses of the processing memory.

In this exemplary embodiment, the maximum brightness value may be calculated as follows. The image data, which includes brightness values of respective pixels 22A, is serially input to the brightness characteristic detection circuit 1 in an order beginning from the upper left of the frame 21 as shown by the arrows in FIG. 4. Accordingly, brightness values of the pixels in the pixel blocks 22 in the upper-most row, or #0 to #31 blocks of the pixel blocks 22, are firstly processed.

That is, using the adder 11 and the accumulated value register 12, which are combined to function as an accumulator, and the processing memory 13, accumulate brightness values of the pixel blocks 22 in the first row (#0 to #331 blocks) are calculated and stored in respective addressed of the processing memory 13. The processing memory 13 has a number of addresses capable of storing the respective accumulated brightness values of the pixel blocks 22 arranged in each of the rows (i.e., 32 in the case shown in FIG. 3).

Then, using the combination of the first comparator 14A and the maximum value register 15A and the combination of the second comparator 14B and the minimum value register 15B, the accumulated brightness values stored in respective addressed of the processing memory 13 are compared with each other, and a largest and the smallest ones of them are selected and held in the maximum value register 15A and the minimum value register 15B, respectively.

In practice, the comparison of the accumulated brightness values may be performed using the combination of the comparator 14A or 14B and the register 15A or 15B shown in FIG. 2 as follows. Firstly, the first one of the accumulated brightness values is held in the register 15A and 15B as a current maximum and a current minimum value, respectively. Then the next one of the accumulated brightness values is compared with the current maximum and the current minimum value held in the registers 15A and 15B using the comparators 14A and 14B, respectively. The larger and the smaller one of them are held in the register 15A and 15B as updated current maximum and minimum values in the registers 15A and 15B. The same procedure may be repeated until the last one of the accumulated brightness values stored in the processing memory 13 is compared with the current maximum and minimum values and the larger and the smaller ones of them are held in the registers 15A and 15B.

Then, the processing of the brightness values of the pixels within the pixel blocks 22 in the next row (#32 to #63 blocks) are performed.

That is, using the accumulator (the combination of the adder 11 and the accumulated value register 12) and the processing memory 13, accumulate brightness values of the pixel blocks 22 in the second row are calculated and stored in respective addressed of the processing memory 13. Further, using the combination of the comparators 14A and 14B and the registers 15A and 15B, the accumulated brightness values stored in respective addressed of the processing memory 13 are compared with each other. The accumulated brightness values stored in the processing memory 13 are also compared with the values previously held in the registers 15A and 15B, which are the maximum and the minimum values among the accumulated brightness values of the pixel blocks in the previous row,. The largest and the smallest ones of them are selected and held in the registers 15A and 15B, respectively.

The comparison may also be performed using the combination of the comparators 14A and 14B and the registers 15A and 15B. At this time, the largest and the smallest ones of the accumulated brightness values of the pixel blocks 22 in the previous row are previously held in the maximum value register 15A and the minimum value register 15B, respectively. Accordingly, the first and the following ones of the accumulated brightness values stored in the processing memory 13 may be repeatedly compared with the current maximum or minimum value hest in the register 15A or 15B, and the larger and the smaller ones of them may be held in the registers 15A and 15B, respectively.

The same procedure is repeated until the brightness values of the pixels in the pixel blocks 22 in the last one of the rows are processed. As a result, the accumulated brightness values of all pixel blocks are compared with each other and the largest and the smallest ones of them are selected and held in the maximum value register 15A and the minimum value register 15B, respectively.

Thus, the exemplary brightness characteristic detection circuit 1 shown in FIG. 2 includes a processing memory 13 capable of storing the accumulated brightness values of the pixel blocks 22 in one of the rows. The processing memory 13 is repeatedly used during for obtaining the maximum or the minimum brightness value. Accordingly, it is not necessary to use a memory that is capable of storing the accumulated brightness values of all the pixel blocks 22. Thus, the image data processing apparatus requires a small area of the semiconductor substrate and may be realized with a low cost.

Furthermore, the processing memory is also used repeatedly for calculating the accumulated brightness values of the pixel blocks 22 in a row.

As shown in FIG. 5, plurality of pixels 22A in each pixel block 22 is arranged along a plurality of lines in the horizontal direction. As shown by the arrows in FIG. 4, the image data is serially input to the brightness characteristic detection circuit 1 in an order beginning from the pixels in the upper-most line in the pixel blocks 22 in the upper-most row.

First of all, brightness values of the 1st to the 32nd pixels in the 1st line of #0 block of the pixel blocks 22 are accumulated, using the adder 11 and the accumulated value register 12, and a first intermediate accumulated brightness value is produced. The produced value is stored in address 0 h of the processing memory 13. Further, brightness values of the pixels in the 1st line within #1 to #31 blocks of the pixel blocks 22, which are arranged in the horizontal direction in the upper-most row, are accumulated. Needless to say, the accumulated value register 12 is cleared before accumulating the brightness values of the pixels 22A in different pixel blocks 22. Produced first intermediate accumulated brightness values of the #1 to #31 blocks are stored in addresses 1 h to 1 Fh, respectively, of the processing memory 13. Here, “h” indicates that the addresses are shown in hexadecimal values.

Then, the brightness values of the pixels in the second line within #0 to #31 pixel blocks 22 are accumulated, using the same combination of the adder 11 and the accumulated value register 12, to the first intermediate accumulated brightness values, which are read from the respective addresses of the processing memory 13. Produced updated intermediate accumulated brightness values are stored again in the respective addresses of the processing memory 13.

The same procedure is repeated until the brightness values of the pixels 22 in the last (the lower-most) line are accumulated, and the accumulated brightness values of all pixels 22A in the pixel blocks 22 are produced and stored in the respective addresses of the processing memory 13.

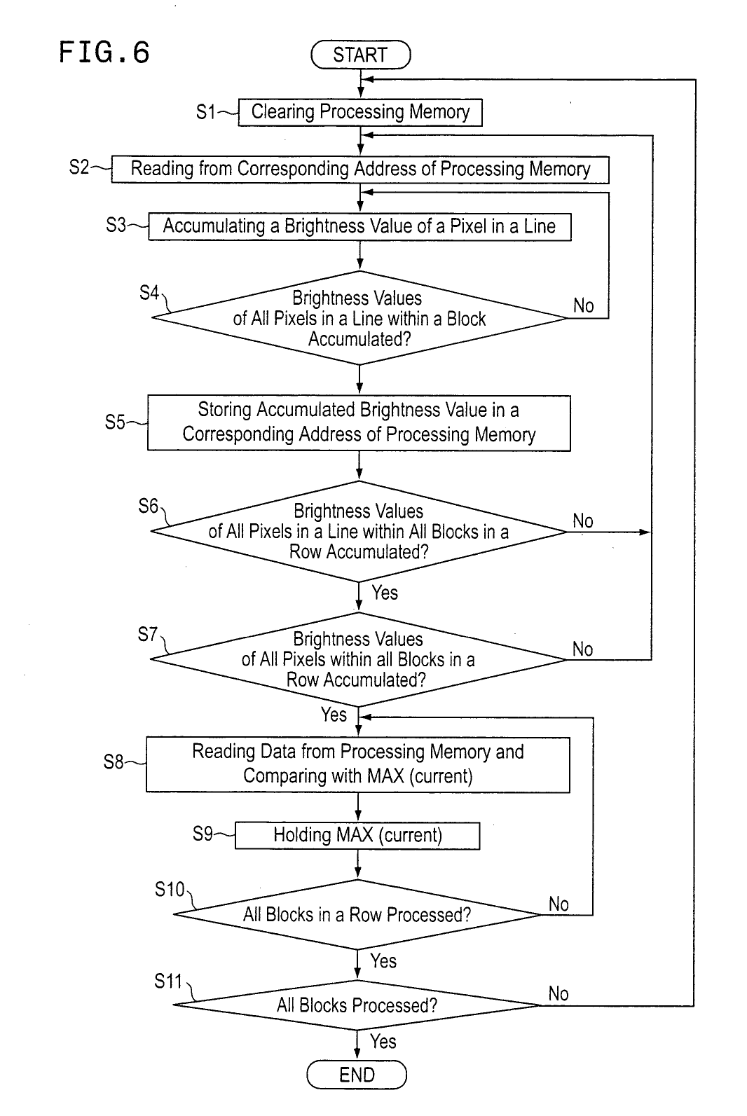

The procedure for obtaining the maximum brightness value of the frame 21 will be further explained with reference to FIG. 6. FIG. 6 is a flow chart showing an exemplary procedure for calculating a maximum brightness value. Note that, although FIG. 6 only shows an exemplary procedure for calculating the maximum brightness value, the exemplary procedure may similarly be used for calculating a minimum brightness value.

After clearing the processing memory 13 (Step S1), accumulation of the brightness value of a pixel in a line (Step S3) is repeated until the brightness values of all pixels in a line within a block are accumulated (Step S4). The accumulated brightness value (intermediate accumulated brightness value) thus produced is stored in a corresponding address of the processing memory 13 (Step S5). The same procedure is further repeated until the brightness values of pixels in the line within all blocks in a row is accumulated and stored in the corresponding addresses of the processing memory 13 (Step S6).

Next, the brightness values of the pixels in the second lines in #0 to #31 blocks of the pixel blocks 22 are processed. Prior to the accumulation of the brightness values of the pixels in the second line of the #0 block of the pixel blocks 22, the intermediate accumulated brightness value of the first line of #0 block of the images blocks 22 is read from the processing memory 13 (Step S2 in FIG. 6). The brightness values of 32 pixels in the second line within the #0 block of the pixel blocks 22 are accumulated to the read value (Steps S3 and S4 in FIG. 6) and re-written into the address 0 h of the processing memory 13 (Step S5 in FIG. 6).

The same procedure is repeated until all intermediate accumulated brightness values of the first line of #0 to #31 blocks of the images blocks 22 are read from the processing memory 13, and the brightness values of respective 32 pixels in the second line within all pixel blocks in a row are accumulated to the read values, and re-written into respective addresses 0 h to 1 Fh of the processing memory 13 (Steps S2 through S6 in FIG. 6). At this point, 32 intermediate accumulated brightness values of the pixels in the 1st and the 2nd lines of #0 to #31 blocks of the images blocks 22 are stored in addresses 0 h to 1 Fh of the processing memory 13.

The same procedure is further repeated until the brightness values of the pixels in the 32nd line are accumulated (Steps S2 through S7 in FIG. 6). At this point, brightness values of all 1,024 pixels within all blocks in the upper-most row, or #0 to #31 blocks of the pixel blocks 22, are accumulated and the accumulated brightness values are stored in respective addresses 0 h to 1 Fh of the processing memory 13.

Next, the largest one of the accumulated brightness values stored in the processing memory 13 is selected.

Firstly, for example, the accumulated brightness value read from address 0 h of the processing memory 13 is stored in the maximum values register 15A as a current maximum value MAX (current). Then, the accumulated brightness values stored in the processing memory 13 are read from the next address 1 h and compared with the current maximum value MAX (current) using the comparator 15A (Step 8 in FIG. 6), and the large one of them is stored in the maximum value register 15A as an updated current maximum value MAX (current) (Step 9 in FIG. 6). This procedure is repeated until all pixel blocks 22 in the upper-most row is processed (Steps S8 through S10 in FIG. 6), i.e., until the accumulated brightness values store in all addresses of the processing memory 13 are read and compared. At this point, the largest one of the accumulated brightness values of 32 (#0 to #31) pixel blocks 22 in the upper-most row (MAX (0-31)) is selected and stored in the maximum value register 15A.

The same procedure (Steps S1 through S10 in FIG. 6) is repeated for the #32 to #63 pixel blocks 22 and the largest one of the accumulated brightness values of the pixels within the #32 to #63 blocks MAX (32-63) is selected. The largest value MAX (32-63) is compared with MAX (0-31) and the larger one of them is stored in the maximum value register 15A as the updated current maximum brightness value MAX (current).

In practice, when using the exemplary brightness characteristic detection circuit 1 shown in FIG. 2, the selection of the largest one of the accumulated brightness values of the pixels within the #32 to #63 pixel blocks and the comparison with MAX (0-31) may be performed by repeatedly reading the accumulated brightness values of the #32 to #63 pixel blocks from the processing memory 13, comparing with the current maximum value MAX (current) stored in the maximum value register 15A, and storing the larger one of them as the updated current maximum brightness value MAX (current) in the maximum value register 15A (Steps S8 though S10 in FIG. 6).

The same procedure (Steps S1 through SS10 in FIG. 6) is further repeated until all pixel blocks are processed (Step S11 in FIG. 6), i.e., until accumulated brightness values of the blocks 22 in the lower-most row (#736 to #767 blocks in the case shown in FIG. 3) are compared with the current maximum value MAX (current). At this point, the largest one of the accumulated brightness values of all 768 pixel blocks 22 is selected and stored in the maximum value register 15A as the current maximum value MAX (current).

Because each pixel block 22 includes 32·32=1,024 pixels, the maximum brightness value may be calculated by dividing the MAX (current) by 1,024 using the divider 16A. Note that a simple procedure of discarding a predetermined number of the lowest bits may perform the division operation in the divider 16A. The division may also be performed during the calculation of the accumulated brightness values. In other words, the accumulated brightness values stored in the processing memory 13 may be the values divided with the number of pixels in a pixel block 22.

It is also possible to supply the value MAX (current) to the corrosion property setting circuit 2 as the maximum brightness value, without performing the division. In practice, however, it is preferable to perform the division so that the maximum brightness value is obtained as a data having a number of bits that is easy to be handled in the correction parameter setting circuit 2.

According to this exemplary embodiment, the average brightness characteristic is detected by accumulating the brightness values of the pixels in each of the pixel blocks. The maximum brightness value of the frame 21 is obtained by selecting the largest one of the accumulated brightness values. Accordingly, even when a noise is incorporated into a pixel block, the influence of the noise may be suppressed.

This exemplary embodiment is based on an idea of, instead of detecting brightness characteristics of individual pixels, obtaining the maximum brightness value from average brightness characteristics detected for respective pixel blocks. Accordingly, even if pixel data with a high gray-scale level exists in the frame 1 as a noise, the influence of the noise may be suppressed to a level that may be ignored.

In determining average brightness characteristic of each pixel blocks, it is not always necessary to use the brightness values of all pixels in the pixel block. It is also possible to use brightness values of selected ones of the pixels as long as a number of pixels sufficient to suppress the influence of the noise are selected. In such a case, when calculating the maximum brightness value using the flow shown in FIG. 6, it is preferable to select the same number of pixels for detecting the average brightness characteristic in each of the pixel blocks.

The minimum brightness value within a frame may also be obtained using the similar procedure. In the description of the exemplary embodiment for obtaining the maximum brightness value described above, “larger” and “largest” may be substituted with “smaller” and “smallest”, and “maximum” and “MAX” may be substituted with “minimum” and “MIN”, respectively.

Same as the case of obtaining the maximum brightness value, even if pixel data with a low gray-scale level exists in a frame 1 as a noise, the influence of the noise to the minimum brightness value may be suppressed to a level that may be ignored.

It is not always necessary to use brightness values of pixels in the entire area of the frame to detect the brightness characteristic. The influences of brightness values of pixels in some areas, such as peripheral areas, to the brightness characteristic of the frame 21 are small. Accordingly, it is possible to exclude, from the beginning, such a low influence areas from the processing. That is, the pixel blocks 22 for detecting the average brightness characteristics may be arranged in a specified area of the frame, which may be the entire area of the frame 21 or a partial area within the frame 21.

In the exemplary embodiment, accumulated brightness values of the pixel blocks 22 are calculated during processing for obtaining the maximum brightness value. Thus, an average brightness value for the entire frame 21 may be obtained by adding the accumulated brightness values of all pixel blocks 22 in the frame 21. In other words, the exemplary brightness characteristic detecting circuit 1 shown in FIG. 3 may also calculate the average brightness value for the entire frame by only adding small number of additional components. A more appropriate setting of the correction parameters may be realized by using the average brightness value in addition to the maximum and/or the minimum brightness values.

### Second Embodiment

In the first exemplary embodiment, the brightness characteristics, or the accumulated brightness values, of all pixel blocks are equally utilized in determining the brightness characteristic of the frame. That is, the accumulated brightness values of all pixel blocks are compared with each other to obtain the maximum or the minimum brightness value without treating any of them differently. However, it is possible to set indexes to be considered in comparing the brightness characteristics of the pixel blocks.

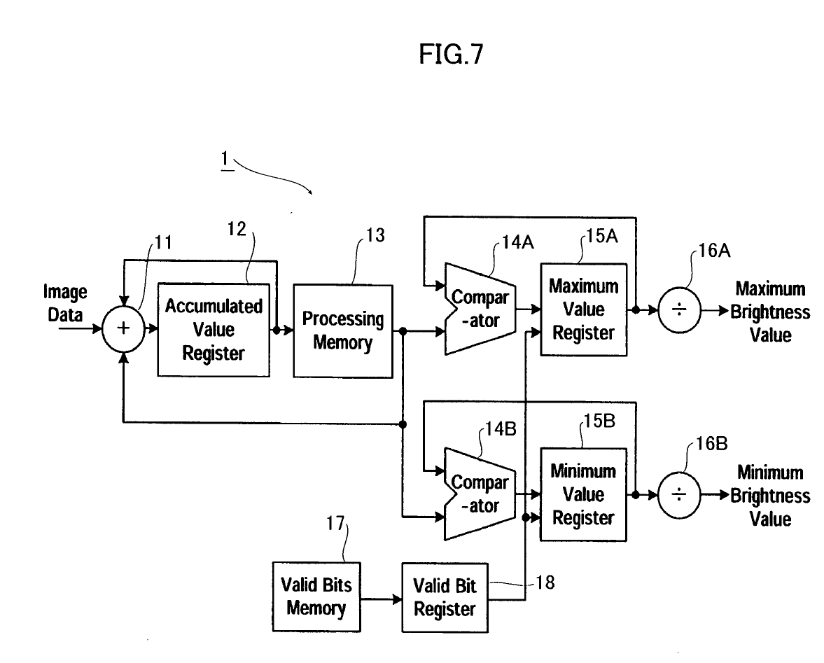

FIG. 7 is an exemplary block diagram showing another exemplary embodiment of brightness characteristic detection circuit 1. In this exemplary embodiment, valid bits are set for the pixel blocks as the indexes and are stored in a valid bits memory 17. In order to use the valid bits, necessary ones of them are read from the valid bit memory 17 and held in a valid bit register 18. The valid bits held in the valid bit register 18 controls the maximum value register 15A and the minimum value register 15B. Thereby, each of the pixel blocks is set, depending on the value of the corresponding valid bit, to be valid or invalid during obtaining the maximum or the minimum brightness value.

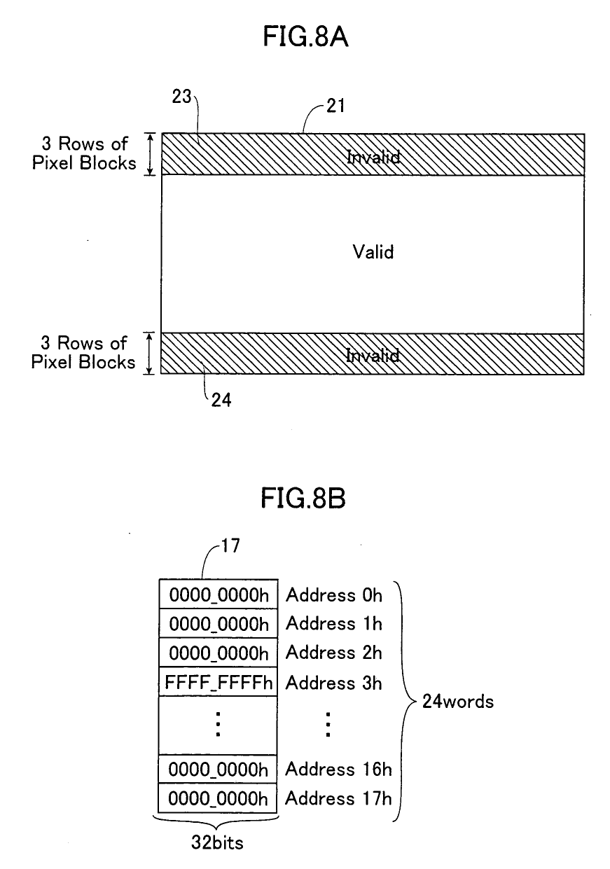

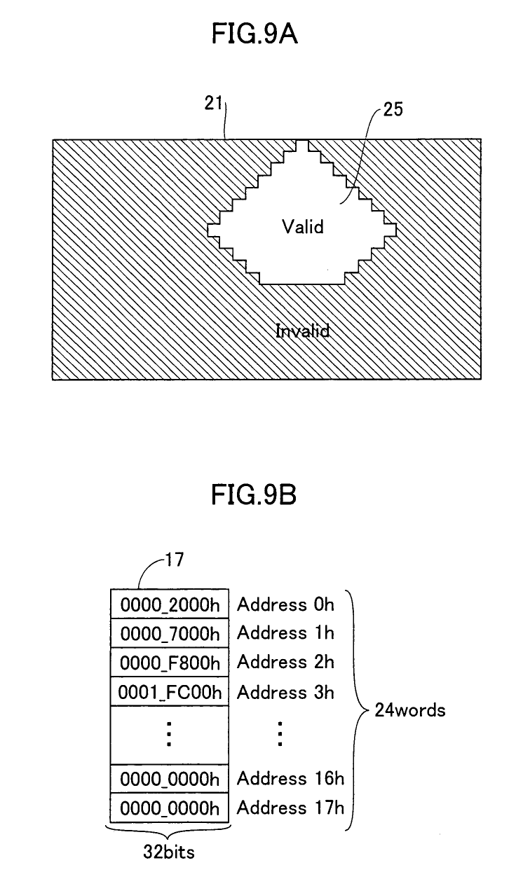

It is assumed that the frame 21 is divided as shown in FIG. 3. That is, the frame 21 is divided into 32 pixel blocks in the horizontal direction and into 24 pixel blocks in the vertical direction, or into 765 divided blocks in total. FIG. 8A shows an exemplary arrangement of valid and invalid pixel blocks. In the example shown in FIG. 8A, the upper-most three rows 23 and the lower-most three rows 24 are set to be invalid, and are excluded from the processing. FIG. 9A shows another exemplary arrangement of valid and invalid pixel blocks. In the example shown in FIG. 9A, the pixel blocks in the predefined area 25 are set to be valid and are used for the processing. The remaining blocks are set to be invalid and excluded from the processing.

In this exemplary embodiment, the valid bit is provided for each of the pixel blocks 22 as a flag. When calculating the maximum or the minimum brightness value, each block is determined to be valid or invalid referring to the value of the valid bit. In the exemplary circuit construction shown in FIG. 7, the valid bits memory 17 is constructed as a 32-bits·24-words memory block. One-bit memory element is provided for each pixel block. As shown in FIG. 8B and 9B, “1” is written in the bits corresponding to valid blocks, and “0” is written in the bits corresponding to invalid blocks.

Before starting to process the accumulated brightness values of the first pixel block in a row, the valid bits corresponding to the pixel blocks in the row may be read from the valid bit memory 17. Each of the valid bits indicates whether the corresponding one of the 32 pixel blocks in the row is valid or invalid. The valid bits may be held in the valid bid register and be referenced, when reading and comparing the accumulated brightness values from the processing memory 13. That is, the accumulated brightness value is stored as MAX (current) or MIN (current) only when the corresponding pixel block is valid.

As explained above, valid bits corresponding to respective pixel blocks may be provided, and the valid bits may be referenced to specify the pixel blocks to be utilized for obtaining the maximum or the minimum brightness value.

Further, it is also possible to provide a plurality of valid bits, instead of a single bit, for each of the pixel blocks. Thereby, it is possible to give weights to specific pixel blocks, instead of merely setting each of the blocks to be valid or invalid. When 2-bits valid bits are provided for each of the pixel blocks, for example, four levels of weight coefficients, i.e., “00”, “01”, “10”, and “11” may be set for each of the pixel blocks. The weight coefficient is considered when comparing the accumulated brightness values of the pixel blocks. Thus, the maximum or the minimum brightness value that is to be used in the correction of, for example, contrast of the image, may be calculated by differentiating the areas, or the pixel blocks of high and low importance.

As explained above, according to exemplary embodiments of image data processing apparatus, methods of processing image data, and methods of detecting brightness characteristic according to this invention, a frame is divided into a plurality of divided areas and brightness characteristic of the image data is obtained by calculating a maximum or a minimum brightness value by detecting average brightness characteristics of respective divided areas. Accordingly, even if a noise is incorporated into a pixel, the influence of the noise may be suppressed.

So far, exemplary image data processing apparatus, methods of processing image data, and methods of detecting brightness characteristic according to this invention are explained in detail in reference to specific embodiments. However, this invention is not limited to the embodiments described above, but various improvements and modifications may be made within the spirit of this invention.

What is claimed is:

1. An image data processing apparatus for generating display data to be output to a display device from input image data, the apparatus comprising:
a brightness characteristic detection circuit that detects a brightness characteristic of the input image data; and
a correction circuit that generates the display data by correcting the input image data with a correction parameter set in accordance with the detected brightness characteristic, wherein:
the image data includes brightness values of pixels in a frame; and
the brightness characteristic detection circuit detects the brightness characteristic of the image data by dividing a specified area of the frame into a plurality of divided areas including respective pluralities of the pixels, calculating respective average brightness characteristics of the divided areas, and comparing the average brightness characteristics of the divided areas with each other to obtain at least one of a maximum and a minimum brightness value of the frame.

2. The apparatus according to claim 1, wherein the detection circuit divides the specified area of the frame such that the divided areas are arranged in respective pluralities of rows and columns.

3. The apparatus according to claim 1, wherein the detection circuit calculates accumulated brightness values of the divided areas as the respective average brightness characteristics by accumulating the brightness values of the pixels within each of the divided areas.

4. The apparatus according to claim 3, wherein the detection circuit calculates the accumulated brightness values of the divided areas by accumulating the brightness values of a same number of pixels within each of the divided areas.

5. The apparatus according to claim 3, wherein the detection circuit divides the specified area such that each of the divided areas includes a same number of the pixels.

6. The apparatus according to claim 3, wherein the detection circuit further calculates an average brightness value of the frame by adding the accumulated brightness values of the divided areas, and detects the brightness characteristic of the image data in accordance with the average brightness value and the at least one of a maximum and a minimum brightness values of the frame.

7. The image data processing apparatus according to claim 1, wherein the detection circuit is capable of setting respective indexes for the divided areas such that the indexes are considered when comparing the average brightness characteristics of the divided areas.

8. The image data processing apparatus according to claim 7, wherein the index is one of a valid/invalid flag and a weighting coefficient.

9. The image data processing apparatus according to claim 3, wherein:
the detection circuit divides the specified area of the frame such that the divided areas are arranged in a plurality of rows including respective pluralities of the divided areas; and
the detection circuit includes:
an accumulator that accumulates the brightness values of the pixels within each of the divided areas to produce the accumulated brightness values of the divided areas;
a processing memory capable of storing the accumulated brightness values of the divided areas in any one of the rows produced by the accumulator; and
a comparator that selects at least one of a largest and a smallest one of the accumulated brightness values of the divided areas stored in the processing memory.

10. A method of processing image data, comprising:
receiving image data including brightness values of a plurality of pixels in a frame;
detecting a brightness characteristic of the image data; and
generating a display data by correcting the image data with a correction parameter set in accordance with the detected brightness characteristic,
wherein the detecting includes:
dividing a specified area of the frame into a plurality of divided areas including respective pluralities of the pixels;
calculating average brightness characteristics of the divided areas; and
comparing the average brightness characteristics with each other to obtain one of a maximum and a minimum brightness value of the frame.

11. The method according to claim 10, wherein:
the calculating includes accumulating the brightness values of the pixels in each of the divided areas to produce accumulated brightness values of the divided areas as the average brightness characteristics of the divided areas; and
the comparing is performed such that at least one of a largest and a smallest one of the accumulated brightness values of the divided areas is selected as the at least one of a maximum and a minimum brightness value of the frame.

12. The method according to claim 11, wherein:
the dividing is performed such that the divided areas are arranged in a plurality of rows including respective pluralities of the divided areas; and
the calculating and the comparing includes the steps of:
(a1) producing the accumulated brightness values of the divided areas in a first one of the rows and storing the produced accumulated brightness values in respective addresses of a processing memory;
(a2) selecting at least one of a largest and a smallest one of the values stored in the processing memory and holding the selected one of values in a register;
(a3) producing the accumulated brightness values of the divided areas in a next one of the rows and storing the produced accumulated brightness values in the respective addresses of the processing memory;
(a4) selecting the at least one of a largest and a smallest one among the values stored in the processing memory and the value previously held in the register, and holding the selected one of the values in the register; and
(a5) repeating the steps (a3) and (a4) until the at least one of a largest and a smallest one among the accumulated brightness values of the divided areas in a last one of the rows stored in the respective addresses of the processing memory and the value previously held in the resister is selected and held in the register as the at least one of a maximum and a minimum brightness values of the frame.

13. The method according to claim 12, wherein:
the plurality of pixels of each of the divided areas are arranged in a plurality of lines; and
the accumulated brightness values of the divided areas are calculated, for each of the rows, by the steps of:
(b1) accumulating the brightness values of the pixels in a first one of the lines in each of the divided areas to produce intermediate accumulated brightness values of the divided areas and storing the produced values of the divided areas in the respective addresses of the processing memory;
(b2) accumulating the brightness values of the pixels in a next one of the lines in each of the divided areas to the values previously stored in the respective addresses of the processing memory to produce update intermediate accumulated brightness values of the divided areas and storing the produced values of the divided areas in the respective addresses of the processing memory; and
(b3) repeating the step (b2) until the brightness values of the pixels in a last one of the lines in each of the divided areas are accumulated and the produced updated intermediate accumulated brightness values of the divided areas are stored in the respective addresses of the processing memory as the accumulated brightness values of the divided areas.

14. A method of detecting a brightness characteristic of image data including brightness values of a plurality of pixels in a frame, the method comprising:
dividing a specified area of the frame into a plurality of divided areas including respective pluralities of the pixels;
calculating average brightness characteristics of the divided areas; and
comparing the average brightness characteristics with each other to obtain at least one of a maximum and a minimum brightness value of the frame.

15. The method according to claim 14, wherein:
the calculating includes accumulating the brightness values of the pixels in each of the divided area to produce accumulated brightness values of the divided areas as the average brightness characteristics of the divided areas; and
the comparing is performed such that at least one of a largest and a smallest one of the accumulated brightness values of the divided areas is selected as the at least one of a maximum and a minimum brightness value of the frame.

16. The method according to claim 15, wherein:
the dividing is performed such that the divided areas are arranged in a plurality of rows including respective pluralities of the divided areas; and
the calculating and the comparing includes the steps of:
(a1) producing the accumulated brightness values of the divided areas in a first one of the rows and storing the produced accumulated brightness values in respective addresses of a processing memory;
(a2) selecting at least one of a largest and a smallest one of the values stored in the processing memory and holding the selected one of values in a register;
(a3) producing the accumulated brightness values of the divided areas in a next one of the rows and storing the produced accumulated brightness values in the respective addresses of the processing memory;
(a4) selecting the at least one of s largest and a smallest one among the values stored in the processing memory and the value previously held in the register, and holding the selected one of the values in the register; and
(a5) repeating the steps (a3) and (a4) until the at least one of a largest and a smallest one among the accumulated brightness values of the divided areas in a last one of the rows stored in the respective addresses of the processing memory and the value previously held in the resister is selected and held in the register as the at least one of a maximum and a minimum brightness value of the frame.

17. The method according to claim 16, wherein:
the plurality of pixels of each of the divided areas are arranged in a plurality of lines; and
the accumulated brightness values of the divided areas are calculated, for each of the rows, by the steps of:
(b1) accumulating the brightness values of the pixels in a first one of the lines in each of the divided areas to produce intermediate accumulated brightness values of the divided areas and storing the produced values of the divided areas in the respective addresses of the processing memory;
(b2) accumulating the brightness values of the pixels in a next one of the lines in each of the divided areas to the values previously stored in the respective addresses of the processing memory to produce update intermediate accumulated brightness values of the divided areas and storing the produced values of the divided areas in the respective addresses of the processing memory; and
(b3) repeating the step (b2) until the brightness values of the pixels in a last one of the lines in each of the divided areas are accumulated and the produced updated intermediate accumulated brightness values of the divided areas are stored in the respective addresses of the processing memory as the accumulated brightness values of the divided areas.
